(19) United States
(12) Patent Application Publication
(10) Pub. No.: US 2012/0249587 A1
(43) Pub. Date: Oct. 4, 2012

(54) KEYBOARD AVATAR FOR HEADS UP DISPLAY (HUD)

(76) Inventors: Glen J. Anderson, Beaverton, OR (US); Philip J. Corriveau, Forest Grove, OR (US)

(21) Appl. No.: 13/079,657

(22) Filed: Apr. 4, 2011

(51) Int. Cl. G09G 5/00

(52) U.S. Cl. 345/633; 345/8; 345/156

(57) ABSTRACT

In some embodiments, the invention involves using a heads up display (HUD) or head mounted display (HMD) to view a representation of a user's fingers with an input device communicatively connected to a computing device. The keyboard/finger representation is displayed along with the application display received from a computing device. In an embodiment, the input device has an accelerometer to detect tilting movement in the input device, and send this information to the computing device. An embodiment provides visual feedback of key or control actuation in the HUD/HMD display. Other embodiments are described and claimed.

### FIELD OF THE INVENTION

An embodiment of the present invention relates generally to heads-up displays and, more specifically, to a system and method for utilizing a heads-up or head mounted display to view a keyboard/input device and finger location relative to the input device, in addition to a screen or monitor view in the display.

### BACKGROUND INFORMATION

Various mechanisms exist for allowing a user to view a display without having to look down. Heads-up displays (HUDs) and head-mounted displays (HMDs) allow people to see displays without looking down at a computer. HUDs/HMDs are becoming much smaller and more flexible, more like a pair of sun glasses, and therefore more popular. A HUD/HMD may be used as a display for a notebook computer, in existing systems. This can be very useful while working on airplanes and in other situations where heads-up is beneficial. People nearby cannot see the user's display, and the user does not need as much room to work on the notebook; trying to use a notebook computer in economy class on a plane can be very uncomfortable.

With existing technology, touch typists can already use a HUD/HMD with a notebook on a plane and use the keyboard and mouse on the notebook without having to see the notebook keyboard. However, most people need to be able to see the keyboard, relative to their fingers, while they type, and seeing the location of the pointing device and volume controls is helpful too. A HUD/HMD does not allow this.

### BRIEF DESCRIPTION OF THE DRAWINGS

The features and advantages of the present invention will become apparent from the following detailed description of the present invention in which:

FIG. 1 illustrates an embodiment of a keyboard avatar system using a smart phone with integrated camera, keyboard and HMD, according to an embodiment of the invention;

FIG. 2A illustrates an image of a keyboard and fingers from the point of view of reverse facing camera, according to an embodiment of the invention;

FIG. 2B illustrates a rotated image of the keyboard and fingers seen in FIG. 2A, according to an embodiment of the invention;

FIG. 2C illustrates a translation of the image of FIGS. 2A-B to a perspective as seen from the user, according to an embodiment of the invention;

FIG. 3A illustrates an integrated display for viewing an HUD/HMD which combines the expected display output from a user's session and an image of a finger/keyboard, according to an embodiment of the invention;

FIG. 3B illustrates an integrated display for viewing an HUD/HMD which combines the expected display output from a user's session and an avatar finger/keyboard representation, according to an embodiment of the invention;

FIG. 4 illustrates an embodiment of a keyboard avatar system using a camera mounted in a docking station coupled to an input board HMD; and

FIG. 5 illustrates an embodiment of a keyboard avatar system using a camera mounted on a platform in a location relative to an input board, and an HMD.

### DETAILED DESCRIPTION

An embodiment of the present invention is a system and method relating to wireless display technology that may be applied to heads up and head mounted displays (HUD/HMD) in situations as implementations become smaller, allowing a wireless HUD/HMD. Wireless protocol 802.11 is available on some commercial flights and may be more widespread in the near future, enabling use of embodiments described herein to be used. Bluetooth technology may be used as the protocols allow increased bandwidth in the future. A user may position an integrated notebook camera to look down at the user's fingers on a keyboard, and then see their fingers on the HUD/HMD, along with the expected display. With this approach, however, the video is “upside down” from the normal keyboard perspective that a user needs, and lighting conditions may not be good enough to see the fingers and keyboard clearly. Having a single keyboard layout and touchpad limits the user experience. In embodiments of the invention a user may easily change input devices while continuing to keep the HUD/HMD on. In embodiments, a system mounted light source, or infrared source may be used to get a clearer picture of finger location on the input device.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given. For purposes of illustration and simplicity, the term heads up display (HUD) may be used to also indicate a head mounted display (HMD) in the description herein, and vice-a-versa.

Embodiments of the invention include a system that takes advantage of existing technologies to allow a user to see a representation of their fingers on the HUD or HMD in relation to the keyboard and other controls. This allows a non-touch typist to use a notebook without having to see it directly.

In one embodiment, a physical keyboard is not necessary. A rigid surface, referred to herein as an “input board,” with a laser plane or a camera may be used to sit on the user's lap or on a tray table. The input board may be compact in size, perhaps the size of a standard sheet of paper (8.5×11 in.). The HUD/HMD may display a virtual keyboard for the user that seems to the user to be laid over the input board. The input board need not have markings for keys or controls, but may be imprinted with a grid or corner markers only. The user may type on this surface and exchange the virtual representation to a variety of other virtual input devices, as well.

The input board may be coupled with accelerometers and other sensors to detect tilting and gestures of a user. For example, a user might lay out virtual pegs on the board to create a customized pinball game. The user would then use flick gestures or tilt the whole input board to move the virtual ball around the surface. The visual feedback, including a representation of the user's hands, would be displayed on the HMD/HUD.

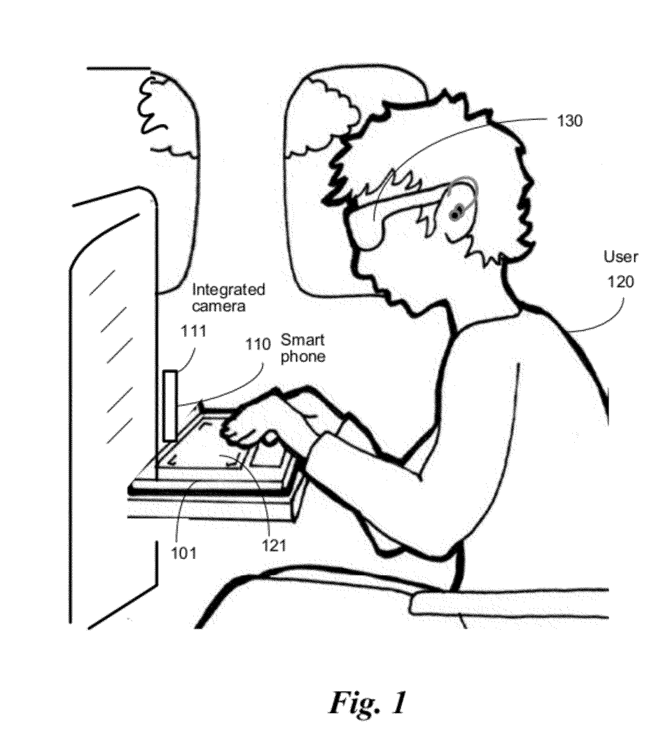

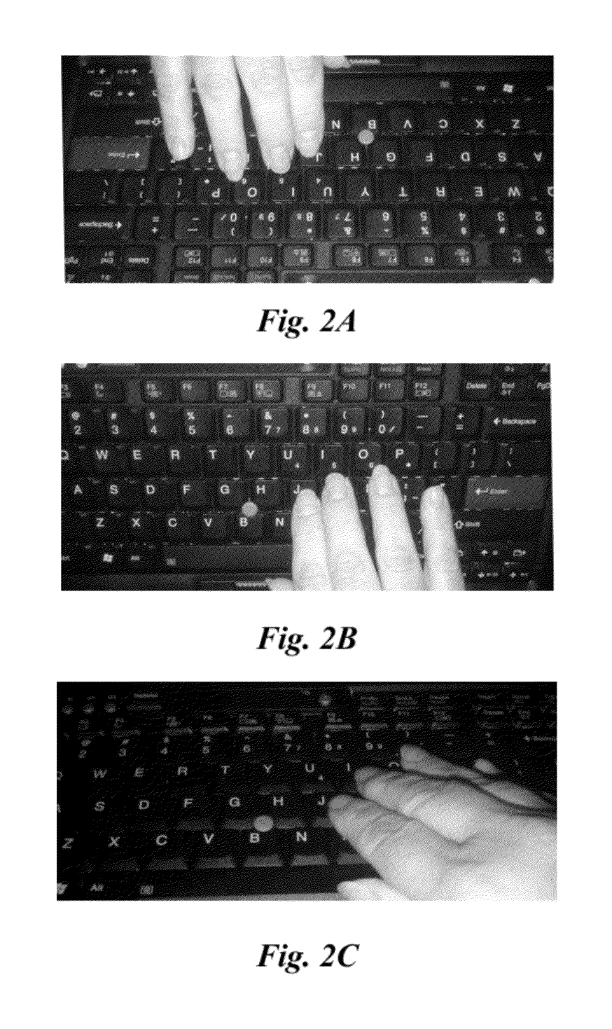

FIG. 1 illustrates high level components of a keyboard avatar for HUD/HMD 130, according to an embodiment of the invention. A notebook (or other computing device) 101 with a pivoting camera 111 may be used to capture the user's (120) hands over the keyboard. In an embodiment, the camera 111 may be integrated with a smart phone 110. FIG. 2A illustrates an example image of a user's hand on the keyboard from the perspective of the camera, according to one embodiment. The video frames may be stretched to correct the camera perspective so that the video image would appear form the user's point of view (as opposed to the camera's point of view). A simple transposition algorithm may be used in an application to take the incoming video and reverse it (FIG. 2B). Another algorithm may be used to alter the image somewhat to show a display to the user that mimics the perspective and angle as if the camera were at the approximate location of a user's eyes (FIG. 2C). These transposition algorithms may be configurable so the user may choose a more desirable perspective image.

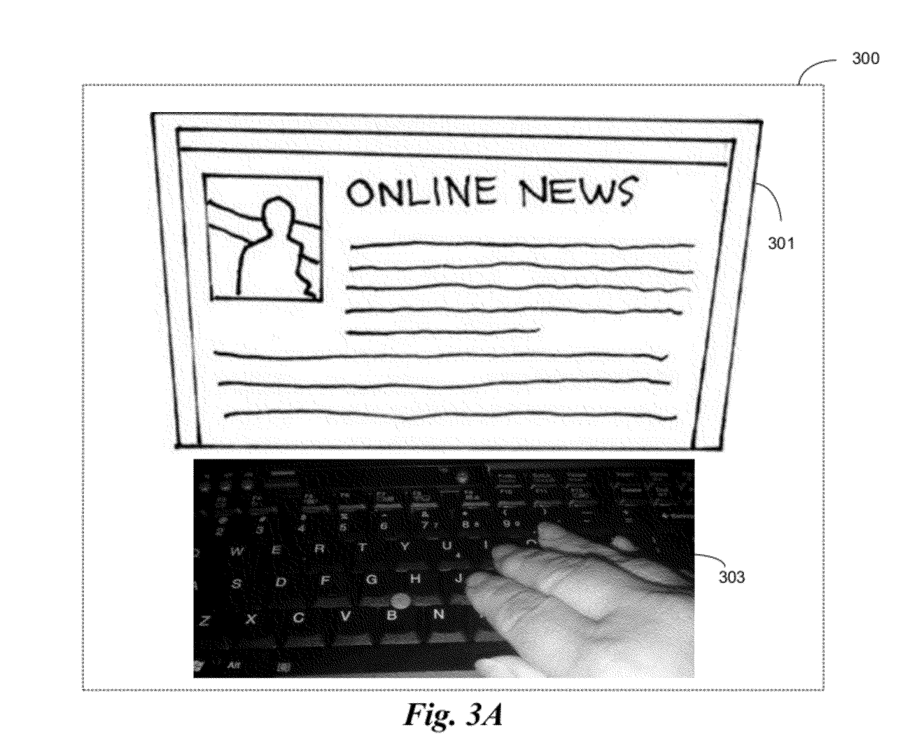

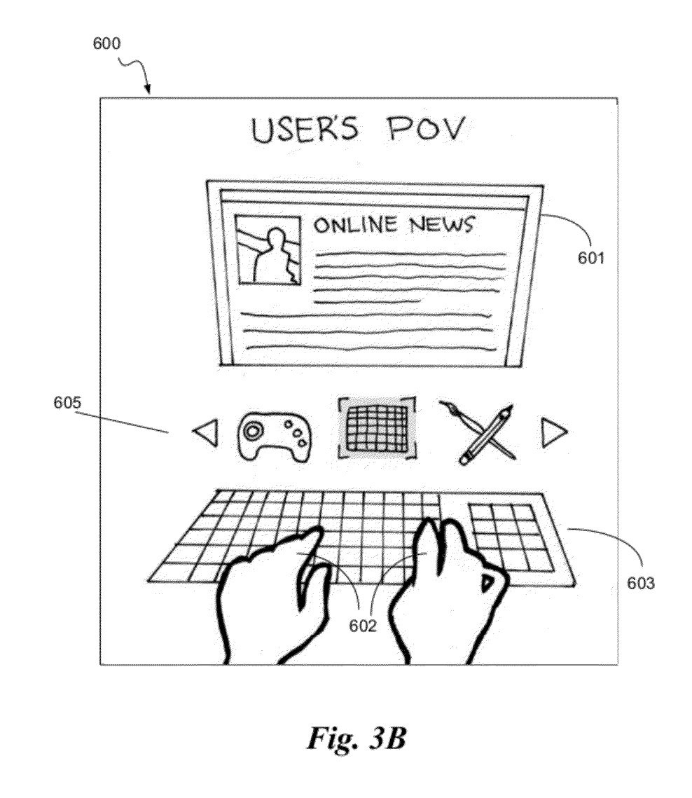

Referring now to FIG. 3A, the application may then display 300 the keyboard and finger video 303 adjacent to the main application (e.g., a word processor, spreadsheet program, or drawing program, game, etc.) 301 that is in use. This video approach requires suitable lighting and a particular camera angle from the integrated camera 111.

In another embodiment, instead of viewing an actual photographic image or video of a keyboard and user's hands, instead the user sees a visual representation of hands on keyboard, or avatar, as shown in FIG. 3B. In this embodiment, the location of the user's fingers on or near the keyboard may be sensed by infrared, or other movement sensor. A artificial representation of the fingers (avatar) 602 relative to the keyboard 603 is then provided in place of the video graphic (303), and then displayed with the current application 601. This method creates a mix between a virtual reality system and real-life, physical controls. In this approach, regular camera input would be optional, thus saving power, and with the ability to be used under a wider variety of lighting conditions and with no concern for proper camera angle. The avatar of hands and keyboard 602/603 may be displayed 600 on the HUD/HMD with the application being used 601, as in FIG. 3A (but with the avatar instead of actual video). This avatar representation may also include a game controller and/or virtual input device selection user interface (U/I) 605.

Creating and displaying a representation of the hands and keyboard may be performed in various ways. One approach is to analyze an incoming standard video or an incoming infrared feed. The regular video or infrared video may then be analyzed by software, firmware or hardware logic in order to create a representation of the user's hands and keyboard. For poor visible lighting conditions, a variety of methods for enhancing video clarity may be used, such as altering wavelengths that are used in the translation of the video, capturing a smaller spectrum than is available with the camera in use, or providing an additional lighting source, such as a camera mounted LED.

In another embodiment, instead of using an actual keyboard at 121 (FIG. 1), an input board may be used. The input board may be made of flexible material to enable rolling, or a stiffer board with creases for folding, for easy transportation. The input board may include a visible grid or be placed at a known location relative to the camera or sensing equipment with pegs or other temporary fastening means to provide a known perspective of user's fingers to the input board keys, buttons, or other input indicators. Using an input board obviates the need for a full size laptop device to be placed in front of the user, when space is at a minimum. The input board may virtualize the input device on a smaller scale than a full size input device, as well.

Referring again to FIG. 1, HUDs and HMDs 130 are known and available for purchase in a variety of forms, for instance in the form of eye glasses. These glasses display whatever is sent from the computing device. Video cameras 111 coupled with PCs are already being used to track hands for gesture recognition. Camera perspective may be corrected to appear as user perspective through standard image stretching algorithms. Horizontal and vertical lines of the keyboard 121 may provide a reference point to eliminate the angle distortion or to reverse the angle to approximately 30 degrees (or other perspective consistent with a user's view) at the user's direction. The input board may be implemented using laser plane technology, such as that to be used in the keyboard projected to be available from Celluon, Inc. When the user's fingertips break a projected plane that is parallel to the surface, an input is registered. Alternatively, technology such as that in the Touchsmart system available from Hewlett Packard may be used. This technology is an array of LEDs and light sensors that track how a user's fingers break a plane. Various resistive or capacitive touchpad technologies could be used as well.

In another embodiment, the input board may have additional sensors, such as accelerometers. Tilting of the board then signals input for movement of a virtual piece on the board. The physics software to drive such applications is already in use in a variety of smart phones, PDAs and gaming software. However, the existing systems provide no visual feedback on finger position relative to an input device. In an embodiment, the HUD display will show the user an image representation, either avatar or video, of the input board with the tilting aspect. Another embodiment will show only the game results in the display, expecting the user to be able to feel the tilt with his/her hands.

In an embodiment, the input board has either no explicit control or key locations, or the controls may be configurable. Game or application controls (605) for user input may be configured to be relative to a grid or location on the video board, or distance from the camera, etc. Once configured, the input sensing mechanism associated with the board will be able to identify which control has been initiated by the user. In embodiments implementing tilting or movement of the input board, it may be desired to mount the camera to the board to simplify identification of movements. Further, visual feedback of the tilting aspect may be turned off or on, based on the user's desire, or application.

A camera (RGB or infrared) for the input board may be used to track user hands and fingers relative to the input board. The camera may be mounted on the board, when a laptop with camera is not used. Two cameras may perform better than a single camera to prevent “shadowing” from the single camera. These cameras may be mounted on small knobs that would protect the lens. Such dual camera systems have already been proposed and specified for tracking gestures. Alternatively, a computing device, such as a smart phone 110 with integrated Webcam 111, may be docked on the input board with the user-facing camera in a position to capture the user's hand positions.

In an embodiment, logic may be used to receive video or sensor input and interpret finger position. Systems have been proposed and embodied for recognizing hand gestures (See, U.S. Pat. No. 6,002,808 and “Robust Hand Gesture Analysis And Application In Gallery Browsing,” Chai, et al., 18 Aug., 2009, first version appearing in IEEE Conference on Multimedia and Expo 2009, ICME 2009, June. 28-Jul. 3, 2009, pp. 938-941, available at URL ieeexplore*ieee*org/stamp/stamp.jsp?arnumber=05202650); and recognizing facial features using a 3D camera (See, “Geometric Invariants for Facial Feature Tracking with 3D TOF Cameras,” Haker et al., In IEEE Sym. on Signals Circuits & Systems (ISSCS), session on Alg. for 3D ToF-cameras (2007), pp. 109-112). It should be noted that periods in URLs appearing in this document have been replaced with asterisks to avoid unintentional hyperlinks. Methods used or proposed for recognizing gestures and facial features may be adapted to identify hand and finger movement in proximity of a keyboard or input device, as described herein.

Logic or software that recognizes fingers in an image or video to analyze gesture input already exists. These existing algorithms may identify body parts and interpret their movement. In an embodiment finger or hand recognition algorithm logic is coupled with logic to add the video or avatar image to the composite video sent to the HUD/HMD. Thus, the image or video seen by the user will include the keyboard/input device, hand video or avatar, as well as the monitor output. A feedback loop from the keyboard or other input controls allows the avatar representation to indicate when a real control is actuated. For example, a quick status indicator may appear over the tip of a finger in the image to show that the underlying control was actuated.

In an embodiment using an avatar for the fingers and keyboard, the image of the fingers may be visually represented to be partially transparent. Thus, when an indicator is highlighted directly over a key/control to show that the key/control was pressed, the user can see the indicator through the transparency of the finger image on the display, even though the user's actual fingers are covering the control on the keyboard or input board.

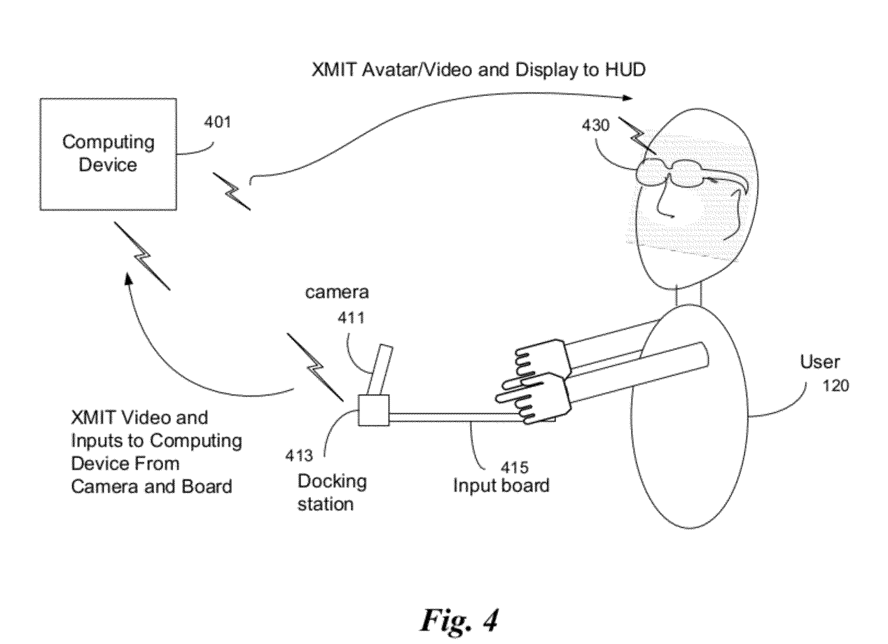

Referring to FIG. 4, an alternative embodiment using an input board rather than a keyboard is shown. The user 120 has a HUD/HMD 430 which is connected wirelessly to a computing device 401 for receiving images corresponding to finger position on the input board 415 and the application display (301). In this alternative embodiment, the user types or provides input at an input board 415. The input board 415 may be coupled to a docking station 413. A camera, or smart device with integrated camera, 411 may be docked in the docking station 413, which may placed at a known location relative to the input board 415. It will be understood that a variety of means may be used to calibrate the camera with board position, as discussed above. The docking station 413 may include a transmitter for transmitting video of the input board and finger location to the computing device 401. The docking station may also be equipped with sensors to identify key presses, mouse clicks, and movement of the input board, when equipped with an accelerometer, and transmit the input selections to the computing device 401. It will be understood that any of the communication paths, as illustrated, may be wired or wireless, and the communication paths may use any transmission protocol known or to be invented, as long as the communication protocol has the bandwidth for real time video. For instance, Bluetooth protocols existing at the time of filing may not have appropriate bandwidth for video, but video-friendly Bluetooth protocols and transceivers may be available in the near future.

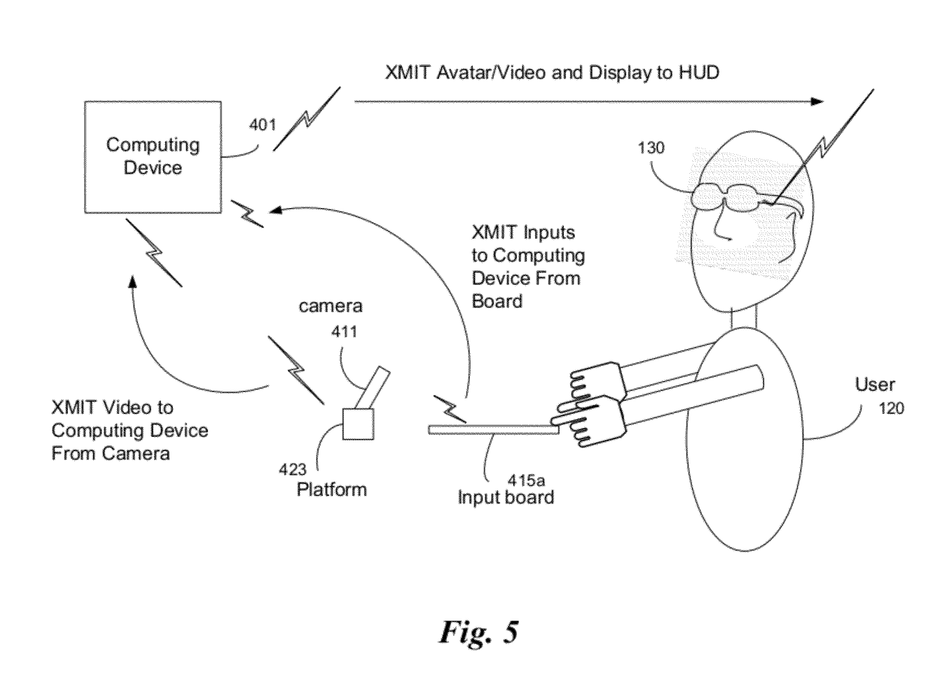

Another alternative embodiment is illustrated in FIG. 5. This embodiment is similar to that shown in FIG. 4. However, in this embodiment, the input board 415a is not directly coupled to a docking station. Instead, the input board may communicate user inputs via its own transmitter (not shown). The camera 411 may be coupled or docked on a separate platform 423, which is placed or calibrated to a known relative position to the input board 415a. The platform, which may be fully integrated with the camera, or smart device, transmits video of the input board and keyboard position to the computing device 401. The computing device 401 transmits the display and keyboard/finger video or avatar to the user HUD/HMD 130.

In an embodiment, the computing device 401 translates the video to the proper perspective before transmitting to the HUD/HMD 130. It will be understood that functions of the camera, calibration of relative position, video translation/transposition, input identification and application, etc. may be distributed among more than one processor, or processor core in any single or multi-processor, multi-core or multi-threaded computing device without departing from the scope of example embodiments of the invention, as discussed herein.

For instance, in an embodiment, the camera is coupled to a smart device which performs the translation of input board/finger video to an avatar representation before transmitting the avatar image to the computing device for merging with the application display. This embodiment may reduce bandwidth requirements in the communication to the computing device from the camera, if the avatar representation is generated at a lower frame rate and/or with fewer pixels than an actual video representation would require.

In another embodiment, the camera may be integrated into the HUD/HMD. In this case, minimal translation of the keyboard/finger image will be required because the image will already seen from the perspective of the user. One embodiment requires the HUD/HMD or integrated camera to have a transmitter as well as receiver to send the camera images to the computing device to be integrated into the display. In another embodiment, the HUD may include an image integrator to integrate the application or game display received from the computing device with the video or avatar images of the fingers and keyboard. This eliminates the need to send the image from the camera to the computing device and then back to the HUD. Camera movement for HUD/HMD mounted cameras may require additional translation and stabilization logic so that the image appears to be more stable. A visual marker may be placed on the input board/device as a reference point to aid in stabilizing the image.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system comprising:
a computing device communicatively coupled with an input device for user input;
a camera for capturing video images of the user's physical interaction with the input device; and
a heads up display device to receive display images comprising an application display and a representation of the user's physical interaction with the input device.

2. The system as recited in claim 1, wherein the computing device receives input events from the input device wirelessly.

3. The system as recited in claim 1, wherein the camera is mounted on a platform communicatively coupled to the computing device and separate from the input device.

4. The system as recited in claim 1, wherein the camera is mounted on a docking station coupled to the input device.

5. The system as recited in claim 4, wherein the camera is integrated with a smart device, and wherein the smart device is mounted in the docking station.

6. The system as recited in claim 1, wherein the input device comprises one of a keyboard or input board.

7. The system as recited in claim 6, wherein the input device comprises an input board, and wherein the input board is configured to enable a virtual representation of the user's interaction with the input board in the heads up display.

8. The system as recited in claim 7, wherein the virtual representation of the input board is configured to represent one of a plurality of input devices, responsive to a user selection.

9. The system as recited in claim 6, wherein the input device comprises a flexible input board capable of being at least one of rolled or folded.

10. The system as recited in claim 1, wherein the computing device is configured to translate a video representation received from the camera to a user perspective aspect, before sending the video representation to the heads up display.

11. The system as recited in claim 10, wherein the computing device is configured to combine the user perspective video representation and application display and to transmit the combine display to the heads up display.

12. The system as recited in claim 10, wherein the computing device is configured to transmit the application display to the heads up display, and wherein the heads up display is configured to combine the received application display with the user perspective video representation for display to the user.

13. The system as recited in claim 1, wherein the representation of the user's physical interaction with the input device is one of a video image, avatar image and hybrid video and avatar image.

14. The system as recited in claim 13, wherein the representation of the user's physical interaction includes showing actuation of virtual controls in response to user input.

15. The system as recited in claim 1, wherein the representation of the user's physical interaction with the input device further comprises a partially transparent representation of the user's hands overlayed over a representation of the input device.

16. The system as recited in claim 1, wherein the camera is mounted to the heads up display.

17. The system as recited in claim 16, wherein the camera is configured to send video images directly to the heads up display, and wherein the heads up display is configured to merge the application display received from the computing device with video images received from the camera for a combined display to the user.

18. A method comprising:
receiving by a heads up display a representation of an application display for display to a user wearing the heads up display;
receiving by the heads up display a representation of the user's interaction with an input device; and
displaying a combined display of the application display and the user's interaction with the input device on the heads up display, to the user.

19. The method as recited in claim 18, wherein the representation of the application display and representation of the user's interaction with the input device are received by the heads up display as a combined display.

20. The method as recited in claim 18, wherein the representation of the application display and representation of the user's interaction with the input device are received in an uncombined state, and further comprising: combining the received displays by the heads up display before displaying the combined display to the user.

21. The method as recited in claim 18, wherein the representation of the user's interaction with an input device is generated in response to images captured by a camera communicatively coupled to a computing device, the computing device configured to execute the application for display, and wherein the camera is mounted on one of (a) a smart device communicatively coupled to the input device, (b) the heads up display, (c) a platform placed in a position relative to the input device, or (d) a keyboard input of the computing device.

22. The method as recited in claim 21, wherein the camera representation of the user's interaction with the input device is to be translated to an orientation representing a user's point of view of the user interaction before displaying on the heads up display.

23. The method as recited in claim 21, wherein the camera is coupled to a smart device which performs the translation of input board/finger video to an avatar representation before transmitting the avatar image as the representation of the user's interaction with the input device.

24. A method comprising:
receiving a representation of a user's interaction with an input device communicatively coupled to an application running on a computing device;
operating the application responsive to user input on the input device;
combining the representation of a display corresponding to the application and the representation of user's interaction with the input device; and
sending the combined representation of the display to a heads up display unit for display to the user.

25. The method as recited in claim 24, further comprising translating the representation of the user's interaction with the input device to an orientation consistent with a view from the user.

26. The method as recited in claim 25, wherein the representation of the user's interaction with an input device is generated in response to images captured by a camera communicatively coupled to the computing device, and wherein the camera is mounted on one of (a) a smart device communicatively coupled to the input device, (b) the heads up display, (c) a platform placed in a position relative to the input device, or (d) a keyboard input of the computing device.

27. The method as recited in claim 26, wherein the camera is coupled to a smart device which performs the translation of input board/finger video to an avatar representation before transmitting the avatar image as the representation of the user's interaction with the input device.

28. A non-transitory computer readable medium having instructions stored thereon, the instructions when executed on a machine cause the machine to:
receive by a heads up display a representation of an application display for display to a user wearing the heads up display;
receive by the heads up display a representation of the user's interaction with an input device; and
display a combined display of the application display and the user's interaction with the input device on the heads up display, to the user.

29. The medium as recited in claim 28, wherein the representation of the application display and representation of the user's interaction with the input device are received by the heads up display as a combined display.

30. The medium as recited in claim 28, wherein the representation of the application display and representation of the user's interaction with the input device are received in an uncombined state, and further comprising: combining the received displays by the heads up display before displaying the combined display to the user.

31. The medium as recited in claim 28, wherein the representation of the user's interaction with an input device is generated in response to images captured by a camera communicatively coupled to a computing device, the computing device configured to execute the application for display, and wherein the camera is mounted on one of (a) a smart device communicatively coupled to the input device, (b) the heads up display, (c) a platform placed in a position relative to the input device, or (d) a keyboard input of the computing device.

32. The medium as recited in claim 31, wherein the camera is coupled to a smart device which performs the translation of input board/finger video to an avatar representation before transmitting the avatar image as the representation of the user's interaction with the input device.

33. The medium as recited in claim 31, wherein the camera representation of the user's interaction with the input device is to be translated to an orientation representing a user's point of view of the user interaction before displaying on the heads up display.

34. A non-transitory computer readable medium having instructions stored thereon, the instructions when executed on a machine cause the machine to:
receive a representation of a user's interaction with an input device communicatively coupled to an application running on a computing device;
operate the application responsive to user input on the input device;
combine the representation of a display corresponding to the application and the representation of user's interaction with the input device; and
sending the combined representation of the display to a heads up display unit for display to the user.

35. The medium as recited in claim 34, further comprising instructions to translate the representation of the user's interaction with the input device to an orientation consistent with a view from the user.

36. The medium as recited in claim 35, wherein the representation of the user's interaction with an input device is generated in response to images captured by a camera communicatively coupled to the computing device, and wherein the camera is mounted on one of (a) a smart device communicatively coupled to the input device, (b) the heads up display, (c) a platform placed in a position relative to the input device, or (d) a keyboard input of the computing device.

37. The medium as recited in claim 36, wherein the camera is coupled to a smart device which performs the translation of input board/finger video to an avatar representation before transmitting the avatar image as the representation of the user's interaction with the input device.
